(19) United States
(12) Patent Application Publication
(10) Pub. No.: US 2016/0099116 A1
(43) Pub. Date: Apr. 7, 2016

(54) METHODS AND APPARATUS FOR THE PRODUCTION OF CAPACITOR WITH ELECTRODES MADE OF INTERCONNECTED CORRUGATED CARBON-BASED NETWORK

(71) Applicant: Yongzhi Yang, Irvine, CA (US)

(72) Inventor: Yongzhi Yang, Irvine, CA (US)

(21) Appl. No.: 14/816,007

(22) Filed: Aug. 2, 2015

Related U.S. Application Data
(60) Provisional application No. 62/059,906, filed on Oct. 5, 2014.

(51) Int. Cl. H01G 11/86; H01G 13/00; H01G 11/32

(52) U.S. Cl. CPC H01G 11/86; H01G 11/32; H01G 13/00

(57) ABSTRACT

The present invention provides a Digital Lighting Processer (“DLP”) based Light Treatment System (“DLP-LTS”) and methods to reduce portions of the carbon-based oxide film to an interconnected corrugated carbon-based network (ICCN), in order to produce supercapacitors.

### RELATED APPLICATIONS

The present application claims priority to U.S. Provisional Patent Application No. 62/059,906, filed Oct. 5, 2014.

The application listed above is hereby incorporated herein by reference in its entireties.

### FIELD OF THE DISCLOSURE

The present disclosure provides a Digital Light Processing (“DLP”) based Light Treatment System (“DLP-LTS”) and methods to treat the carbon-based oxide film to make an interconnected corrugated carbon based network (“ICCN”) . The DLP-LTS is also used for patterning, and tuning the properties of the ICCN.

### BACKGROUND OF THE INVENTION

With the rapid development of electric cars, smart phones and many other electric devices, researchers have been working hard to develop energy storage solutions that can replace today's batteries.

Today's high capacity batteries are widely used to power electric cars, smart phones and other electric devices. But these batteries take too long to charge. For example, although you can travel 250 to 300 miles with a Tesla Model S electric car, it could take 9.5 hours to fully charge the batteries with a 240V outlet. This is not practical for most of the car users. On the other hand, capacitors can be charged much faster. But the problem is that capacitors store much less energy.

Supercapacitors, also known as ultracapacitors or electric double-layer capacitors (EDLC), are able to hold hundreds of times more electric charge comparing with standard capacitors, and the supercapacitors charge much faster than today's batteries. Therefore, supercapacitors can be used to replace today's high capacity batteries.

A major obstacle with the adaption of Surpercapacitors is that it is very expensive to produce. Researchers in University of California have offered a solution to this problem. In their International Patent Application WO2013134207 A1 titled “Capacitor with electrodes made of an interconnected corrugated carbon-based network”, Maher F. EL-KADY, Veronica A. STRONG, and Richard B. Kaner disclosed a method to use a low cost DVD LightScribe writer to process graphite oxide to produce a graphene-based supercapacitor. The EL-KADY et al patent application includes detailed information on this field, including details on fabrication and testing method.

Inventors Lixing Lao, Heran ma and Jiaxing Lang also disclosed similar method that uses LightScribe writer to process graphite oxide to produce a graphene-based supercapacitor in their Chinese patent applications CN104211047 (A) titled Graphene, graphene electrode, graphene supercapacitor and preparation method thereof, and CN204102724 (U) titled Grapheme supercapacitor and energy storage system. Since the EL-KADY et al patent application has priority date that precedes Lao et al's priority date, we will only use information in EL-KADY's application as background information.

The EL-KADY et al patent application disclosed “a capacitor having at least one electrode made up of an interconnected corrugated carbon-based network (ICCN). The ICCN produced has a combination of properties that includes high surface area and high electrical conductivity in an expanded network of interconnected carbon layers.”

In one embodiment disclosed in the above patent application, “each of the expanded and interconnected carbon layers is made up of a plurality of corrugated carbon sheets that are each one atom thick. The interconnected corrugated carbon-based network is characterized by a high surface area with highly tunable electrical conductivity and electrochemical properties.”

One of the key ideas behind the EL-KADY et al patent is using laser beam to reduce or remove oxygen species from portions of the carbon-based oxide film, such as graphite oxide film. The oxygen species create defects in graphite oxide's electronic structure which make graphite oxide an electrically insulating material. Reducing the oxygen species from portions of the carbon-based oxide film turns these portions into an electronically conductive ICCN. The laser light can reduce the oxygen species since the light is absorbed by the graphite oxide film and converted to heat, which liberates carbon dioxide. The network structure of the ICCN has open pores, and it is a sheet-like structure, which can be intuitively envisioned as looking like the layered structure in a flaky pastry. The open chambers created by the separation of carbon sheets, along with interconnected pores, provide large exposed flat sheet surface area that is readily accessible to electrolyte. This structure contributes to increased charge storage capacity and rapid frequency response of the ICCN.

An embodiment of the method disclosed in the EL-KADY et al patent application is described as follows: “an initial step receives a substrate having a carbon-based oxide film. Once the substrate is received, a next step involves generating a light beam having a power density sufficient to reduce portions of the carbon-based oxide film to an ICCN. Another step involves directing the light beam across the carbon-based oxide film in a predetermined pattern via a computerized control system while adjusting the power density of the light beam via the computerized control system according to predetermined power density data associated with the predetermined pattern.”

It is further described that: “In one embodiment, the substrate is a disc-shaped, digital versatile disc (DVD) sized thin plastic sheet removably adhered to a DVD sized plate that includes a DVD centering hole. The DVD sized plate carrying the disc-shaped substrate is loadable into a direct-to-disc labeling enabled optical disc drive. A software program executed by the computerized control system reads data that defines the predetermined pattern. The computerized control system directs a laser beam generated by the optical disc drive onto the disc-shaped substrate, thereby reducing portions of the carbon-based oxide film to an electrically conductive ICCN that matches shapes, dimensions, and conductance levels dictated by the data of the predetermined pattern.”

For the convenience of further discussion, we will simply refer the process of “using light beam to reduce portions of the carbon-based oxide film to an ICCN” as using the light to “treat” the carbon-based oxide film.

The method disclosed above uses a single laser beam that treats one “point” on the carbon-based oxide film at a time. The “point” is around 1 μm in diameter since the laser beam is typically focused to a diameter around 1 μm.

To improve production efficiency and output, a method needs to be developed that can treat an entire area on the carbon-based oxide film at a time and the area can include millions of points.

Although The EL-KADY et al patent application did mention other lithography techniques and those techniques can indeed treat one entire area at a time, the authors of the application correctly stated that those are “time-consuming and labor-intensive lithography”. By referring to it as “time-consuming and labor-intensive”, the authors clearly imply the traditional mask lithography techniques.

Therefore a maskless lithography technique should be used that can treat an entire area at a time, and yet is not “time-consuming and labor-intensive”. The present invention uses Digital Light Processing based technique, which is a maskless technique which replaces the time-consuming and labor-intensive mask lithography.

The method disclosed in the EL-KADY et al patent application has its limit since the size of the interdigitated electrodes, and therefore the size of the supercapacitor, is limited by the size of the DVD disk. The method disclosed in the present invention does not have such limit. Furthermore, according to the present invention, the ICCN can be tested for quality control purpose without being moved and can be treated again if necessary. It can also be further processed, such as adding electrolyte, without being moved from its place. And it can also be easily placed on a conveyor belt for further processing.

Although there are other methods that can produce larger ICCNs, such as using microwave for the “reduction of graphite oxide”, as described in “Zhu Y et al. Microwave assisted exfoliation and reduction of graphite oxide for ultracapacitors, Carbon (2010), doi:10.1016/j.cabon.2010.02.001”, these methods do not provide precise control on how much reduction is done on each point. By using DVD LightScribe writer, the EL-KADY et al patent application does provide precise control on how much reduction is done at each point “both by controlling the grayscale level used and the number of times the film is reduced by the laser”. However, since DVD rotates to allow DVD laser head to reach each point, when certain area needs to be reduced multiple times, the DVD laser head has to repeatedly pass through areas that do not need to be further reduced, which wastes time. The present invention provides easy and efficient control of light intensity and treatment time on each point, therefore provides efficient and precise control on how much reduction is done on each point.

### SUMMARY OF THE INVENTION

In accordance with the method provided in the present invention, a Digital Light Processing (“DLP”) based Light Treatment System (“DLP-LTS”) is used to treat the carbon-based oxide film to an ICCN . (DLP is a registered trademark of Texas Instruments Incorporated.)

In one possible exemplary embodiment, The DLP-LTS consists of at least one DLP projector, a mechanical system that allow the DLP projector to move freely in×and Y direction, and in Z direction (up and down) if it is needed, and a platform where the mechanical system and the substrate are placed on. The DLP projector includes at least one DLP chip, at least one light source, such as a LED, a laser light source, or a lamp, an electronic control board that controls the DLP chip, and optical components for projecting images to a targeted surface, which in this case would be a carbon-based oxide film instead of a projection screen. The DLP chip is also called a Digital Mirror Device (“DMD”), which consists of arrays of aluminum micromirrors. For example, a 0.95″ DMD consists of 1080 rows and each row has 1920 of micromirrors. Each micromirror can be controlled to tilt −12 or 12 degree, either reflecting light toward the targeted surface (ON) or away from it (OFF). This creates a light or dark pixel on the targeted surface, and each pixel on the targeted surface is the projected image of the corresponding micromirror. For convenience, a pixel projected on the targeted surface is also called a point. By controlling the ON and OFF on each micromirror, the DLP projector will project desired images to the targeted surface. For convenience, we will only use 0-offset projector so it will project to a rectangular area on the targeted surface. We will call this rectangular area the projected display. To show how DLP-LTS can be used to treat an entire area on the carbon-based oxide film at a time and to produce multiple micro-supercapacitors at a time, we look at the following example. Considering the exemplary micro-supercapacitor shown in the FIG. 19C in EL-KADY et al patent application WO2013134207 A1. (The FIG. 19C is included in the present application as FIG. 3.) The micro-supercapacitor is made of two electrodes, each with eight extending electrode digits that are interdigitated with the eight extending electrode digits from the other electrode. This micro-supercapacitor is within a rectangular area with the size of 5350 μm×7530 μm. Since the 0.95″ DMD micromirrors forms a rectangular area of about 20736 μm×11664 μm, with an 1× projector magnification, the size of the projected display would be 20736 μm×11664 μm. That is, the DLP projector would project to a 20736 μm×11664 μm rectangular area on the carbon-based oxide film on the substrate. This 20736 μm×11664 μm rectangular area is large enough to cover four 5350 μm×7530 μm size micro-supercapacitors. That is, the DLP projector can project four images of the 5350 μm×7530 μm size micro-supercapacitor onto the carbon-based oxide film on the substrate. Therefore, instead of using one laser beam to treat an 1 μm point at a time, the DLP-LTS can treat an area that contains hundreds of millions of points at a time and the area is large enough to contain four 5350 μm×7530 μm size micro-supercapacitors. Furthermore, if the projector magnification is 2×, then the DLP-LTS would project to a 41472 μm×23328 μm rectangular area on the carbon-based oxide film on the substrate. The area is large enough to cover sixteen 5350 μ×7530 μm rectangular areas. That is, the DLP projector can project sixteen images of the 5350 μm×7530 μm size micro-supercapacitor onto the carbon-based oxide film on the substrat. Therefore it can treat an area that covers sixteen of these micro-supercapacitors at a time. On other hand, if higher resolution is needed, a projector that de-magnifies can be used. For example, a projector with 3× de-magnification can project a 6912 μm×3888 μm rectangular area to the carbon-based oxide film on the substrate. This 6912 μm×3888 μm rectangular area is not large enough to cover a 5350 μm×7530 μm micro-supercapacitors. But the projector can finish treating portion of the 5350μm×7530μm area first, and then move horizontally to the remaining area to finish treating the area. Due to limitations of the current DLP technology, the de-magnification should be limited to less than 13×.

Using customized software, the total amount of time spent to treat the carbon-based oxide film, and the grayscale level on each point, that is, the light intensity used to treat each point, can be precisely controlled. The reason that customized software is needed is because standard projectors are programmed to display at a frame rate of 24 FPS (frames per second), or 25 FPS, or 30 FPS. That is, each image is displayed for 1/24, or 1/25 or 1/30 second at a time. In order to precisely control the grayscale level and the time each point is treated, the present invention introduces a method which uses a maximum time T to define customized grayscale levels.

### BRIEF DESCRIPTION OF THE DRAWING

FIG. 1 is a partial perspective view of an exemplary embodiment of a DLP projector used in the DLP-LTS;

FIG. 2 is a schematic partial perspective view of an exemplary embodiment of a DLP based Light Treatment System (DLP-LTS) of the present invention.

FIG. 3 shows an exemplary micro-supercapacitors provided in the Patent Application WO2013134207 A1.

FIG. 4 shows a grayscale image that contains four images of the micro-supercapacitors.

### DETAILED DESCRIPTION OF THE INVENTION

The embodiments described below provide sufficient information to enable those skilled in the art to practice the disclosure. It is assumed that those skilled in the art are kept up-to-date with the current technologies in the field. Upon reading the following description with accompanying drawings, those skilled in the art should understand the concepts of the present disclosure and will recognize applications of these concepts not particularly addressed herein. It should be understood that these concepts and applications fall within the scope of the disclosure and the accompanying claims.

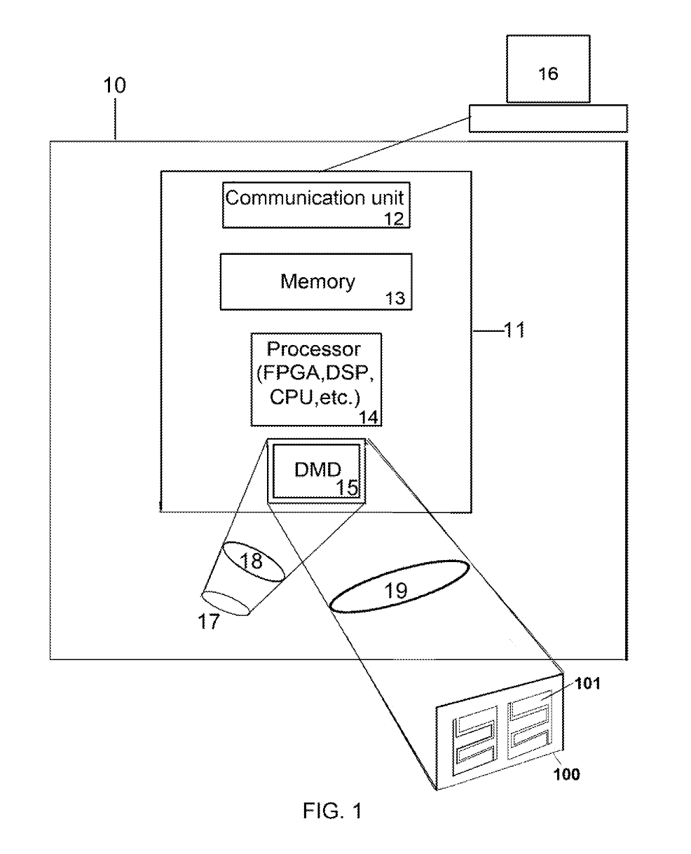

FIG. 1 is a partial perspective view of an exemplary embodiment of an DLP projector in the DLP-LTS. The exemplary DLP projector 10 comprises a control unit 11 which controls the operation of DMD 15. The control unit comprises a processor 14, which is usually a FPGA, but could also be a DSP or any of the other processors such as an ARM CPU. The control unit also comprises memory 13, and communication unit 12, which could support USB, PCIE , Ethernet, WIFI or other means of communications. The DLP projector also comprises a light source 17 and optical unit 18 which are used to illuminate the DMD, and projection lens unit 19 to project the image from DMD to a targeted surface area 100. A computer 16 is used to send images to the memory 13 through communication unit 12. The computer can also be used to configure the control unit, such as setting up the frame rate. Note that once the control unit is configured and images are loaded to the memory, the computer does not have to be connected with the DLP projector. That is, the DLP projector can operator without being connected to the computer. Once it is turned on, it can project a sequence of predetermined images stored in the Memory. 101 is an exemplary image being displayed on the targeted surface 100, such as a carbon-based oxide film layer on a substrate.

The DMD chip can be controlled by customized software that can be stored in Memory 13. The customized software can be written so the light intensity, that is, the amount of light used to treat each pixel, can be precisely controlled, thus providing efficient and precise control on how much reduction is done on each point. In one exemplary embodiment, the control of the light intensity used to treat each pixel is achieved by defining customized grayscale levels, as described below. First, through experiments, deciding the maximum time T, in microseconds, that is needed to treat any given pixel. This can be done by turning all the micromirrors on to treat the entire area within the projected display on a carbon-based oxide film for different amount of time, and test sheet resistance of the resulted ICCN after each treatment. The time that is need to obtain desired sheet resistance in the entire area would be the longest time needed. T is set to be greater than or equal to the longest time needed and T will be called the maximum time. The maximum time T is determined by factors such as the thickness of the carbon sheet, the power of the light source and efficiency of the optical systems. Using the maximum time T, the time scale for how long each pixel is treated is defined as follows. As an example, we will use 8 bit grayscale. For each pixel k, k can be treated for a time duration of gray(k)×T/255 microseconds, where gray(k) can be any integer between 0 and 255 and is called the gray value at k. Note that due to the limitation of the DMD chips, it is recommended that T is chosen so that T/255 is no less than 13 microseconds, which includes the time needed to load the data that controls the tilting of each micromirrors, the time to tilt the micromirrors and for micromirrors to settle down from vibration after tilting. In order to be able to generate any grayscale level gray(k)×T/255, where gray(k) is any integer between 0 and 255, for each pixel, the DMD micromirrors will be controlled to turn on and off 8 times. During the j-th time, where j is an integer between 0 and 7, some DMD micromirrors will be turned on for (2̂j)×T/255 microseconds, while all other DMD micromirrors will be off for the entire (2̂j)×T/255 microseconds. The binary image that is projected during the j-th time is called the j-th bit plane. The total amount of time each micromirror k is turned on is gray(k)×T/255=k0×(2̂0×T/255)+k1×(2̂1×T/255)+k2×(2̂2×T/255)+k3×(2̂3×T/255)+k4×(2̂4×T/255)+k5×(2̂5×T/255)+k6×(2̂6×T/255)+k7×(2̂7×T/255), where each of kj is either 0 or 1, and j is an integer between 0 and 7, and where gray(k) is an integer between 0 and 255 and can be uniquely expressed as gray(k)=k0×2̂0+k1×2̂1+ . . . +kj×2̂j+ . . . +k7×2̂7, that is, for each j, whether kj is 0 or 1 is uniquely determined by the value of gray(k). Note that kj=0 means that the micromirror k is turned off during the time the j-th bit plane is projected, while kj=1 means that the micromirror k is turned on during the time the j-th plane is projected.

For example, if k0=k1= . . . =k7=0, then the micromirror k will be turned on 0 microsecond, which means that the corresponding pixel on the targeted surface area is treated for 0 microsecond. If k0=k2=1 and k1=k3=k4=k5=k6 =k7=0, then the time the micromirror k is on would be k0×(2̂0×T/255)+k2×(2̂2×T/255)=(2̂+2̂2)×(T/255)=5×(T/255) . That is, the corresponding pixel on the target surface is treated for 5×(T/255) microseconds. Similarly if k0=k1=k2=k3=k4=k5=k6=k7=1, then the time the micromirror k is on would be 1×(2̂0×T/255)+1×(2̂1×T/255)+1×(2̂2×T/255)+1×(2̂3×T/255)+1×(2̂4×T/255) +1×(2̂5×T/255)+1×(2̂6×T/255)+1×(2̂7×T/255)=(2̂0+2̂+2̂2+2̂+2̂4+2̂5+2̂6+2̂7)×(T/255)=255×(T/255)=T , which means the corresponding pixel on the target surface is treated for T microseconds. By selecting between 0 and 1 for each of the k0, k1, k2, k3, k4, k5, k6, k7, the pixel corresponding to the micromirror k can be treated for i×(T/255) microseconds for any integer i between 0 and 255. In this exemplary embodiment, the instruction on the light intensity used to treat each pixel is stored in the memory as a 8 bit grayscale digital image. This image determines the shapes, dimensions and conductive levels of the ICCN. Before treating a targeted surface, the DLP-LTS reads the 8 bit grayscale digital image from its memory 13. This image provides a grayscale value for each pixel k, denoted by gray(k). gray(k) is an integer between 0 and 255 and can be uniquely expressed as gray(k)=k0×2̂0+k1×2̂1+k2×2̂2+k3×2̂3+k4×2̂4+k5×2̂5+k6×2̂6+k7×2̂7. The corresponding micromirror k will be turned off in j-th bit plane if kj=0, and will be turned on in j-th bit plane if kj=1, where j=0, 1, 2, 3, 4, 5, 6, 7. For example, if gray(k)=9, since 9=2̂0+2̂3, then k0=k3=1 while k1=k2=k4=k5=k6=k7=0, which means that the micromirror k will be turned on in 0-th and 3-th bit plane and will be turned off in 1-th, 2-th, 4-th, 5-th, 6-th, 7-th bit planes. Therefore, the pixel k is treated for (2̂0×T/255)+(2̂3×T/255)=9×T/255 microseconds.

Note that although 8 bit grayscale is used as an example, one can use different grayscale such as 4 bit grayscale. In general, for any integer N greater than 0, N bit grayscale can be used so each pixel k can be treated for a time duration of gray(k)×T/(2̂N−1) microseconds (gray(k)×T/(2̂N−1) means gray(k) times T and divided by 2 to the N-th power minus 1), where the gray value gray(k) can be any integer between 0 and (2̂N−1). And for each micromirror k, the corresponding pixel is treated for a time duration of gray(k)×T/(2̂N−1)=k0×(2̂0×T/(2̂N−1))+k1×(2̂1×T/(2̂N−1))+ . . . +kj×(2̂j×T/(2̂N−1))+ . . . +k(N−1)×(2̂(N−1)×T/(2̂N−1)), where kj is either 0 or 1 and j is an integer between 0 and (N−1) , and gray(k) is an integer between 0 and 2̂N−1 and can be uniquely expressed as gray(k)=k0×2̂0+k1×2̂1+ . . . +kj×2̂j+ . . . +k(N−1)×2̂(N−1).

Also note that although it is more efficient to use N bit grayscale and use bit plane, one may choose not to use N bit grayscale, that is, one can select a maximum gray value G which is not in the form of 2̂N−1 for any positive integer N.

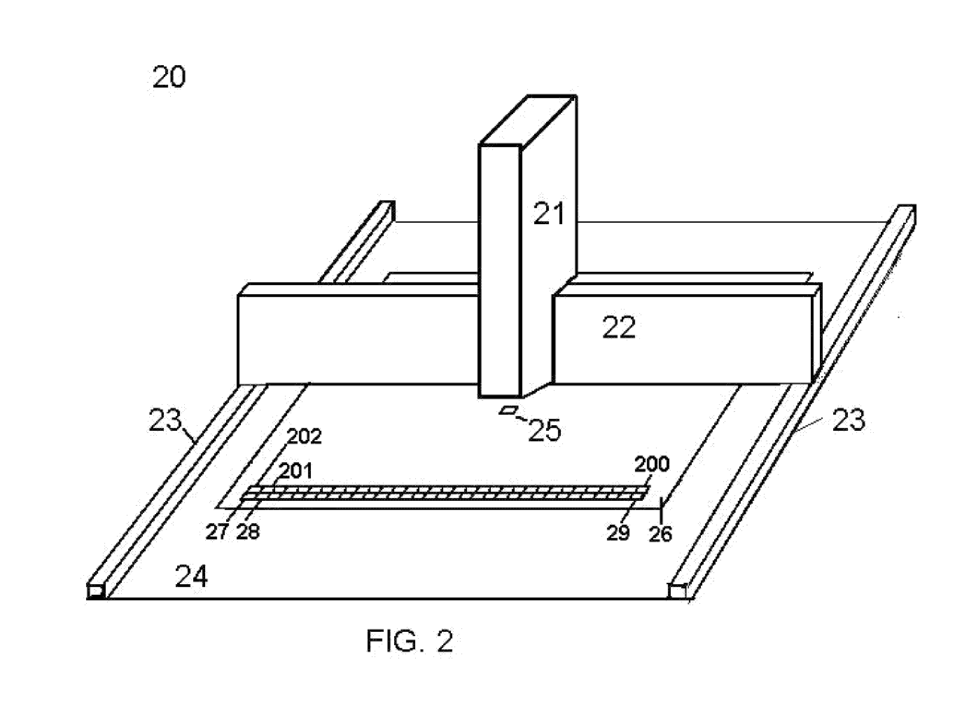

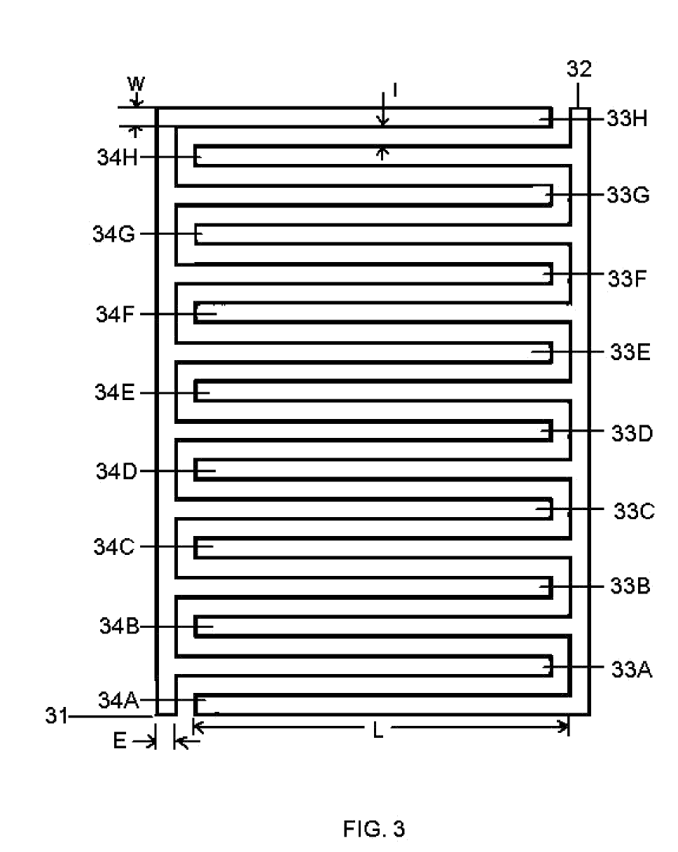

FIG. 2 shows a partial perspective view of an exemplary embodiment of a DLP-LTS 20. It comprises at least one DLP projector unit 21, which projects to a projected display 25 on the targeted surface, which is a carbon-based oxide film on the substrate 26. The substrate 26 and the two tracks 23 are placed on the platform 24. An arm 22 is placed on the tracks 23 and can move back and forth along the tracks 23. The DLP projector unit 21 can also move left and right along the arm 22, thus allow the DLP projector to move on both X (along the arm 22) and Y (along the tracks 23) directions. The projector can also be made to move up and down and change magnifications if it is necessary. As the DLP projector moves along both×and Y directions, it covers different areas on the substrate. If the magnification of the DLP Projector is set to 1×, then each image projected by the DLP projector would be large enough to cover four of the micro-supercapacitors described in the FIGS. 3. 27 and 28 show two different projected displays which are two different areas to be treated.

FIG. 3 shows an exemplary micro-supercapacitors provided in the the EL-KADY et al patent application. This micro-supercapacitor configuration has a first electrode 31 with eight extending electrode digits 33A through 33H. A second electrode 32 has eight extending electrode digits 34A through 34H that are interdigitated with the eight extending electrode digits 33A through 33H.

The extending electrode digits 33A through 33H and the extending electrode digits 34A through 34H are depicted with exemplary individual widths of W=330 μm and with an exemplary length (L) of 4800 μm. The exemplary edge dimension (E) is 200 μm, and the exemplary interspace dimension (I) is 150 μm which is a serpentine gap that separates the first electrode 31 from the second electrodes 32.

Note that due to the micromirror size limitation, the above dimensions need to be modified in the present invention. For example, when the projector magnification is 1×, the dimensions W, L, I, and E need to be the multiples of the micromirror size. In the case when the 0.95″ DMD is used, the dimensions W, L, I, and E need to be the multiples of 10.8 μm, which is the width of a micromirror plus the gap between two micromirrors. For example, W could be either 30 or 31 times 10.8 μm, which is 30×10.8 μm=324 μm, or 31×10.8=334.8 pin, instead of 330 μm; L could be either 444 or 445 times of 10.8 μm, which is 444×10.8=4795.2 μm, or 445×10.8=4806 μm, instead of 4800 μm; I could be either 13 or 14 times 10.8 μm, which is either 13×10.8=140.4 μm, or 14*10.8=151.2 μm, instead of 150 μm; and E could be either 18 or 19 times 10.8 μm, which is either 18×10.8=194.4 μm, or 19×10.8=205.2 μm, instead of 200 μm. If the projector magnification is 2×, then the dimensions W, L, I, and E need to be the multiples of 2 times of the micromirror size. Again assume that the 0.95″ DMD is used, then the dimensions W, L, I, and E need to be the multiples of 2×10.8 μm=21.6 μm. For example, W could be either 15 or 16 times 21.6 μm, which is 15×21.6 μm=324, or 16×21.6=345.6 μm, instead of 330 μm. In general, when using a DLP-LTS to project a predetermined image to treat the area covered by the projected image, the size of any parts of the projected image must follow the following rules: let's call one edge of the DMD chip the×-direction and its perpendicular direction the Y-direction, and for each micromirror, let's call its size along the×-direction the width, denoted by mw, and its size along the Y-direction the height, denoted by mh. Note that in case diamond shaped micromirrors are used, the width and height defined above is actually from tip to tip instead of from edge to edge, which is the case when the micromirrors are rectangular. If the projector magnification is MX, where M is greater than 1 and does not have to be an integer, then the distance along the X-direction between any two points on any edges of the projected image must be i×M×mw (i times M times mw), where i can any integer greater than 1, and the distance along the Y-direction between any two points on any edges of the projected image must be j×M×mh (j times M times mh), where j can any integer greater than 1. On the other hand, if the projector demagnifies and the demagnification is MX, where M is greater than 1 and does not have to be an integer, then the distance along the X-direction between any two points on any edges of the projected image must be i×(1/M)×mw, where i can any integer greater than 1, and the distance along the Y-direction between any two points on any edges of the projected image must be j×(1/M)×mh, where j can any integer greater than 1.

Based on the above notes, we will adjust the sizes in FIG. 3 as follows: W=324 μm, L=4806 μm, I=151.2 μm, and E=194.4 μm. After this adjustment, the micro-supercapacitor in FIG. 3 has the total width of E+I+L+E=194.4+151.2+4806+194.4=5346 μm. And it has total height of 324×16+151.2×15=7452 μm. On the other hand, a 0.95″ DMD has 10.8 μm micromirror pitch, which is the distance between the center of the two neighboring micromirrors, and it has 1920×1080 micromirrors, Therefor the DMD micromirrors occupies a 1920×10.8=20736 μm wide and 1080×10.8=11664 μm height rectangular area. With an 1× projector magnification, the projector can project to a rectangular area of the size 11664 μm×20736 μm on the substrate having a carbon-based oxide film. This 11664 μm×20736 μm rectangular area is large enough to contain four 5346 μm×7452 μm areas.

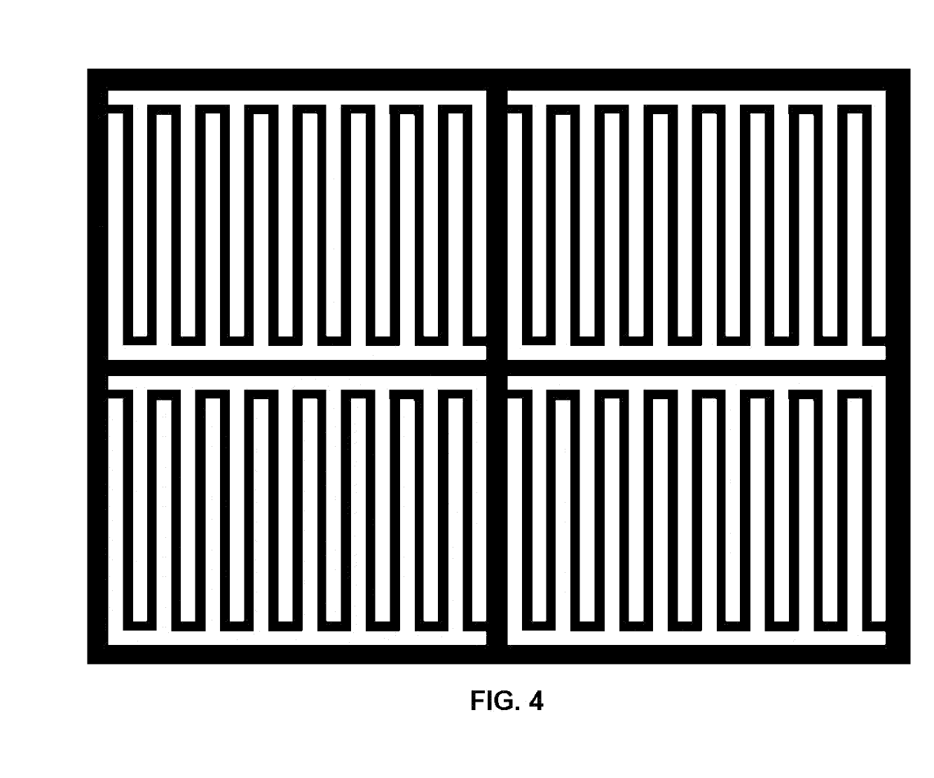

FIG. 4 shows an exemplary grayscale image that contains four micro-supercapacitors with 324 μm space between the two neighboring micro-supercapacitors and 324 μm space around them. Each of the four micro-supercapacitors is an image of the micro-supercapacitor in FIG. 3. And the electrodes in this image are white which means they have higher gray values and will be treated by more light, while the black areas are having gray value equal to 0 and are not treated. The width of this image is 324×3+7452×2=15876 μm, and the height of the this image is 324×3+5346×2=11664 μm. This 11664 μm×15876 μm area is within the 11664 μm×20736 μm projected display. Therefore, the DLP-LTS can project this image to a carbon-based oxide film on a substrate and treat the entire area covered by this image at a time.

If the projector magnification is 2×, then the DLP-LTS would would project an image of the size 23328 μm×41472 μm, which is large enough to cover sixteen 5346 μm×7452 μm rectangular areas. That is, the DLP-LTS can project sixteen images of the micro-supercapacitor in FIG. 3 to targeted surface at a time. That is, the DLP-LTS will treat an area that contains sixteen micro-supercapacitors at a time.

Note that the time, or called exposure time, it takes to treat an area depends on multiple factors such as: the power of the light source; the size of the projected display; and the efficiency of the projector which depends on the optical design and the quality of the optical components. Therefore, each type of TLP-LTS needs to be tested to determine the optimum exposure time. On other hand, by controlling the exposure time and grayscale at each pixel, one can tune the electrical resistance on any point on the carbon-based oxide film on the substrate 26.

In one exemplary implementation as shown in FIG. 2, the DLP projector 21, with 1× magnification, starts operation from lower-left corner of the substrate 26 which is covered by carbon-based oxide film. It treats an 11664 μm×15876μm area 27 first, where the 11664 μm×15876μm area covers four size 5346 μm×7452 μm micro-supercapacitors plus 324 μm spacing between them, and the 11664 μm×15876 μm area is within a 11664 μm ×20736 μm projected display. After the area 27 is treated, the DLP projector 21 then moves on the arm 22 towards right until it reaches the next targeted area 28 whose size is also 11664 μm×15876 μm, then it stops to treat the area 28. It continues to move towards right to treat each 11664 μm×15876 μm targeted area until it reaches the last targeted area 29 on the right edge of the substrate 26. Then the arm 22 will move up on the tracks 23 until it reach the next 11664 μm×15876 μm targeted area 200. The arm will then stop and treat the area 200. Then the DLP projector will starts to move on the arm 22, from right to left to treat another row of targeted areas, until it reaches the last 11664 μm×15876 μm targeted area 202 on the left edge of the substrate 26. The DLP projector will then move up to treat the target area in the third row. This time it will move from left to right again. The DLP projector can keep move this way until it treats all the target areas in all the rows.

Note that using this system, large interdigitated electrodes, and therefore large supercapacitor, can be produced. For example, one supercapacitor may be large enough to occupy four target areas 27, 28, 201 and 202. This larger supercapacitor can be produced by treating the four areas 27, 28, 201 and 202 one by one, or buy using 2× magnification which results in a larger projected display that is large enough to cover all these four areas 27, 28, 201 and 202. In fact, the size of the interdigitated electrodes is only limited by the size of the substrate.

Also note that when considering large magnifications to 3×, 4×, . . . , etc., the power of the light source and therefore the energy projected on each pixel, need to be taken into consideration. Although we would like to increase the power of the light source so we can have large magnifications, too much power may burn micromirrors or make cooling of DLP-LTS too complicated and too expensive. Laser amplifier can be placed between DMD and the targeted area. The laser amplifier would increase the energy being projected on each pixel, without having to increase the power of the light source. But the laser amplifier could make the system more complicated and expensive.

Although one DLP projector is used in the above exemplary embodiment, multiple DLP projectors can be used in a DLP-LTS. For example, eight DLP projectors can be placed next to each other on the arm 22.

Different light sources can be used for the DLP projector, such as infrared laser, visible LED light source, UV light source. While regular DMDs can be used for infrared light source, Texas Instruments does offer DMDs specifically designed for infrared light source.

Although DMD is used in the above exemplary embodiment, one can also use any projection device that is capable of projecting an array of multiple rows and columns of light beams to a targeted surface and is capable of individually controlling the ON and OFF of each pixel. Examples of such devices include LCD (Liquid Crystal Display) panel and LCoS (Liquid Crystal on Silicon) chip. Instead of tilting micromirrors to control the ON and OFF of each pixel, LCD use liquid crystal to let the light pass through or block the light to control the ON and OFF of each pixel, and LCoS use liquid crystal to allow or block the reflection of light to control the ON and OFF of each pixel.

Test points made of metal or other conductive material can be placed beneath the carbon-based oxide film, which allow the real time testing of the sheet resistance of ICCNs to check the quality of the ICCNs or to determine if certain area needs further treatment. Or test device, such as four-terminal sensing or non-contact eddy current based testing devices for measuring sheet resistance, can be installed either below or above the carbon-based oxide film. A good place to put the testing device would be on the DLP projector 21, so the testing device can move to any point on the substrate. If testing shows that further treatment is needed at certain points, the DLP projector can go back to those points to treat them again. These testing tools can also be used to check the quality of the original or treated carbon-based oxide film.

While the micro-supercapacitors described in the Patent Application WO2013134207 A1 is small due to the size limitation of the DVD, the size of the supercapacitors provided by the present invention can be much larger, since the rectangular shaped substrate can be much larger.

The current systems makes it easier for mass production. In the current system, the substrate 26 can be designed to move on a conveyor belt for further fabrication, such as adding electrolyte, in order to make supercapacitor. Or tools used for further fabrication can be placed on the arm 22 which can move along the tracks 23.

Although no mechanical design and control program details or flow chat is given in the above description, the method described above is clear enough, and a person skilled in the field should be able to implement the method and device disclosed in the present invention.

What is claimed is:

1. A method of producing a capacitor comprising:
receiving a substrate having a carbon-based oxide film;
using at least one projection device, which is capable of projecting an array of multiple rows and columns of light beams to a targeted surface and is capable of individually controlling the ON and OFF of each pixel , to generate an array of light beams which project a predetermined grayscale digital image onto the carbon-based oxide film and have a power density sufficient to reduce the potions of the carbon-based oxide film covered by the projected image to a plurality of expanded and interconnected carbon layers that are electrically conductive; and
fabricating the plurality of expanded and interconnected carbon layers into a first electrode and a second electrode.

2. The method of claim 1 wherein the projection device is a DMD (Digital Micromirror Device) projection device;

3. The method of claim 1 wherein the projection device is a LCD (Liquid Crystal Display) projection device;

4. The method of claim 1 wherein the projection device is a LCoS (Liquid Crystal on Silicon) device;

5. The method of claim 1 wherein customized grayscale levels are defined as follows:
determine a maximum time T that is greater than or equal to the time needed to treat any given pixel;
the information on how long each particular pixel should be treated is stored in the memory as a grayscale digital image where each pixel k has a gray value gray(k), where gray(k) is an integer between 0 and a preselected maximum gray value G;
for each pixel k with gray value gray(k), the pixel k is treated for a time duration of gray(k)×T/G microseconds, where gray(k) is an integer between 0 and G.

6. The method of claim 5 wherein the grays value at each pixel is further determined as follows:
Choose an integer N greater than 1, and store the information on how long each particular pixel should be treated in the memory as a N bit grayscale digital image and the maximum gray value G=2̂N−1;
pixels are turned ON and OFF N times, and during the j-th time, some pixels will be turned on for a time duration of (2̂j)×T/(2̂N−1)), while all other pixels will be off for the entire time duration of (2̂j)×T/(2̂N−1)), where j is an integer between 0 and (N−1);
for any given pixel k with gray value gray(k), the time duration the pixel k is treated is expressed as gray(k)×T/(2̂N−1)=k0×(2̂0×T/(2̂N−1))+k1×(2̂1×T/(2̂N−1))+ . . . +kj×(2̂j×T/(2̂N−1))+ . . . +k(N−1)×(2̂(N−1)×T/(2̂N−1)), where kj is either 0 or 1 and j is an integer between 0 and (N−1), and kj=0 means the pixel k is turned off during the j-th time, and kj=1 means the pixel k is turned on during the j-th time, and gray(k) is an integer between 0 and 2̂N−1 and is uniquely expressed as gray(k)=k0×2̂0+k1×2̂1+ . . . +kj×2̂j+ . . . +k(N−1)×2̂(N−1.

7. The method of claim 1 wherein fixed contact test terminals are placed beneath the carbon-based oxide film so that, without moving the carbon-based oxide film, the properties of the carbon-based oxide film can be tested, to check the quality of the original or treated carbon-based oxide film, and/or to determine that if the carbon-based oxide film needs to be treated again.

8. The method of claim 1 wherein movable non-contact test terminals are used and the terminals can move to any point beneath the carbon-based oxide film so that, without moving the carbon-based oxide film, the properties of the carbon-based oxide film can be tested, to check the quality of the original or treated carbon-based oxide film, and/or to determine that if the carbon-based oxide film needs to be treated again.

9. The method of claim 1 wherein movable contact or non-contact test terminals are used and the terminals can move to any point above the carbon-based oxide film so that, without moving the carbon-based oxide film, the properties of the carbon-based oxide film can be tested, to check the quality of the original or treated carbon-based oxide film, and/or to determine that if the carbon-based oxide film needs to be treated again.

10. The method of claim 9 where in the test terminals are placed together or near with the DLP projector so that the same mechanism that enables the movement of the DLP projector is also used to move the terminals.

11. The method of claim 1 wherein some further fabrication steps, such as adding electrolyte, is done without moving the treated carbon-based oxide film.

12. The method of claim 2 wherein the size of any parts of the projected predetermined grayscale digital image must follow the following rules:
If the projection magnification is MX, where M is greater than 1, and the micromirror width is mw and height is mh, then the distance along the X-direction between any two points on any edges of the projected image must be i×M×mw, where i can be any integer greater than 1, and the distance along the Y-direction between any two points on any edges of the projected image must be j×M×mh, where j can be any integer greater than 1;
If the projection demagnification is MX, where M is greater than 1, and the micromirror width is mw and height is mh, then the distance along the X-direction between any two points on any edges of the projected image must be i×(1/M)×mw, where i can be any integer greater than 1, and the distance along the Y-direction between any two points on any edges of the projected image must be j×(1/M)×mh, where j can be any integer greater than 1.

13. An apparatus for generating an array of light beams which project a predetermined grayscale digital image onto the carbon-based oxide film and have a power density sufficient to reduce the potions of the carbon-based oxide film covered by the projected image to a plurality of expanded and interconnected carbon layers that are electrically conductive, comprising:
a. at least one projection apparatus, which is capable of projecting an array of multiple rows and columns of light beams to a targeted surface and is capable of individually controlling the ON and OFF of each pixel;
b. a memory to store a predetermined grayscale digital image where each pixel k has a gray value gray(k), where gray(k) is an integer between 0 and a preselected maximum gray value G;
c. a memory to store a set of instructions, and a processor to execute the said instructions to control the ON and OFF of each pixel, and the said instructions comprising:
read the value gray(k) from the memory for each pixel k;
each pixel k is turned ON for total time duration of gray(k)×T/G, where T is predetermined value that is greater than or equal to the longest time needed to treat any given pixel;

14. The apparatus according to the claim 13, wherein G=2̂N−1 for an integer N greater than 1, and gray(k) is uniquely expressed as gray(k)=k0×2̂0+k1×2̂1+ . . . +kj×2̂j+ . . . +k(N−1)×2̂(N−1) where kj is either 0 or 1 and j is an integer between 0 and N−1, and each pixel k is turned ON for a total time duration of gray(k)×T/(2̂N−1)=k0×(2̂0×T/(2̂N−1))+k1×(2̂1×T/(2̂N−1))+ . . . +kj×(2̂j×T/(2̂N−1))+ . . . +k(N−1)×(2̂(N−1)×T/(2̂N−1)) , where the pixel k is turned ON for a time duration of (2̂j×T/(2̂N−1)) if kj=1 and the pixel k is turned OFF for a time duration of (2̂j×T/(2̂N−1)) if kj=0 for the integer j between 0 and N−1;

15. The apparatus according to the claim 13, wherein fixed contact test terminals are placed beneath the carbon-based oxide film so that, without moving the carbon-based oxide film, the properties of the carbon-based oxide film can be tested, to check the quality of the original or treated carbon-based oxide film, and/or to determine that if the carbon-based oxide film needs to be treated again.

16. The apparatus according to the claim 13, wherein movable non-contact test terminals are included and the terminals can move to any point beneath the carbon-based oxide film so that, without moving the carbon-based oxide film, the properties of the carbon-based oxide film can be tested, to check the quality of the original or treated carbon-based oxide film, and/or to determine that if the carbon-based oxide film needs to be treated again.

17. The apparatus according to the claim 13 wherein movable contact or non-contact test terminals are included and the terminals can move to any point above the carbon-based oxide film so that, without moving the carbon-based oxide film, the properties of the carbon-based oxide film can be tested, to check the quality of the original or treated carbon-based oxide film, and/or to determine that if the carbon-based oxide film needs to be treated again.

18. The apparatus according to the claim 17, where in the test terminals are placed together or near with the DLP projector so that the same mechanism that enables the movement of the DLP projector is also used to move the terminals.

19. The apparatus according to the claim 13, wherein apparatus for further fabrication is included so that some further fabrications steps can be done without moving the treated carbon-based film.
